(19) United States
(12) Patent Application Publication
(10) Pub. No.: US 2020/0229418 A1
(43) Pub. Date: Jul. 23, 2020

(54) FISH DEHOOKING DEVICE

(71) Applicant: ACME UNITED CORPORATION, Fairfield, CT (US)

(72) Inventors: Richard S. Constantine, Monroe, CT (US); John Bracke Arnholt, Key Biscayne, FL (US); Antonio Rabassa, Key Biscayne, FL (US)

(73) Assignee: ACME UNITED CORPORATION, FAIRFIELD, CT (US)

(21) Appl. No.: 16/748,205

(22) Filed: Jan. 21, 2020

Related U.S. Application Data
(60) Provisional application No. 62/794,214, filed on Jan. 18, 2019.

(51) Int. Cl. A01K 97/18

(52) U.S. Cl. CPC A01K 97/18

(57) ABSTRACT

Disclosed is a fish dehooking device for permitting a fisherman to separate a fish from a fishing hook and line. The dehooking device includes a pair of pivotally connected handles one of which is coupled to a dehooking assembly such that its pivotal movement is translated into linear movement of the dehooking assembly. Positioning of a line/hook against the dehooking assembly followed by retraction of the dehooking assembly through the squeezing of the handles together results in the release of a fish from a hook and line.

### CROSS-REFERENCE TO RELATED APPLICATION

The present application relates and claims priority to U.S. Provisional Application No. 62/794,214, filed Jan. 18, 2109, the entire contents of which are hereby incorporated by reference.

### FIELD OF THE INVENTION

The present disclosure is directed generally to fishing tools, and more particularly to a tool for dehooking fish from a fishing line.

### BACKGROUND

Catch and release fishing and/or fishing that benefit from rapid release of a fish from a line requires either a highly skilled fisherman that can quickly detach the hook from the fish, or a tool to assist in the rapid detachment of the fish from the hook. Fish can put up a fight when they are caught by a hook on the end of a fishing line. The act of attempting to free itself from the hook requires tremendous exertion of energy by the fish which depletes its tissue of oxygen through the stress. An oxygen deficit soon occurs, and the muscles begin to function without it. This causes lactic acid to build up on the muscle tissue, and that lactic acid eventually finds its way into the bloodstream. The pH, or measurement of the blood's alkalinity, drops because of the addition of the acid. Once the blood's pH is disrupted, it the fish will oftentimes die.

In addition, commercial fisherman often uses live bait with several baitfish placed on a line at spaced intervals. When the lines are brought in not all the fish have caught a fish and others remain intact within the caught fish's mouth. It is beneficial to take the bait fish off the hook without touching it for the same reasons as stated above—it keeps the fish alive longer.

A typical dehooking tool includes a plier type tool that has a head adapted to engage the leg of a hook. By grasping the head of the hook with the pliers and then manually moving the fish off the hook, the fish can be successfully dehooked. However, this does require manual engagement of the fish itself and can still be somewhat time-consuming depending on how tightly and deep the hook landed in the mouth of the fish.

Accordingly, there is a need in the art for a dehooking took that rapidly dehooks a fish and doesn't require the user to manually handle the fish.

### SUMMARY

The present disclosure is directed to a fish dehooking device.

According to an aspect is a fish dehooking device for permitting a fisherman to separate a fish from a fishing hook and line. The dehooking device comprises first and second handles adapted to be gripped by the fisherman, the first handle being spring biased in an open position and being selectively, manually and pivotally movable towards the second handle through exertion of force to overcome the spring bias; and a dehooking head assembly comprising: an elongated dehooking tab reciprocally movable along a longitudinal axis and interconnected to the first handle, comprising distal and proximal ends; a fish hook and line rod attached to the dehooking tab adjacent the distal end thereof; a pin and pivot link assembly attaching the dehooking tab to the first handle, whereby pivotal movement of the first handle is translated into linear movement of the pin and pivot link; and a dehooking cover comprising a slot formed therein in a position that permits reciprocal movement of the fish hook and line rod into and out of the slot.

According to an embodiment, the bias is created by a spring that interconnects the first handle to the second handle.

According to an embodiment, the fish hook and line rod extends along an axis that is transverse to the longitudinal axis.

According to an embodiment, the pin and pivot link assembly comprise: first and second elongated linkages pivotally connected to one another at respective ends thereof by a first pin; a second pin that attaches the first elongated linkage to the dehooking tab; and a third pin that connects the second elongated linkage to the first handle.

According to an embodiment, wherein the dehooking cover is positioned in covering relation to a portion of the dehooking tab and in uncovered relation to the fish hook and line rod.

According to an aspect is a method for separating a fish from a fishing hook and line using a fish dehooking device having first and second handles pivotally connected to one another and a dehooking head assembly that is reciprocally movable in response to pivotal movement of the first and second handles and includes a slotted cover into which and out of which the dehooking head assembly is reciprocally movable, comprising the steps of: positioning the hook and line adjacent to the dehooking head assembly; pivotally moving the first handle towards the second handle, whereby the dehooking head assembly to move towards the slotted cover; and rotating the dehooking device while the first handle is pivotally moved towards the second handle.

According to an embodiment, the method comprises the further step of the further step of sliding the dehooking device along the fishing line until a fish caught on a second fishing hook is engaged.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a perspective view of a fishing dehooker device, in accordance with an embodiment.

FIG. 2 is a first side view of a fishing dehooker device, in accordance with an embodiment.

FIG. 3 is a second side view of a fishing dehooker device, in accordance with an embodiment.

FIG. 4 is a front elevation view of a fishing dehooker device, in accordance with an embodiment.

FIG. 5 is a rear elevation view of a fishing dehooker device, in accordance with an embodiment.

FIG. 6 is a top plan view of a fishing dehooker device, in accordance with an embodiment.

FIG. 7 is a bottom plan view of a fishing dehooker device, in accordance with an embodiment.

FIG. 8 is a partially exploded perspective view of a fishing dehooker device, in accordance with an embodiment.

FIG. 9 is a partially exploded perspective view of a fishing dehooker device, in accordance with an embodiment.

FIG. 10 is cross-sectional view of a fishing dehooker device taken along section line 10-10 of FIG. 7, in accordance with an embodiment.

FIG. 11 is an exploded perspective view of a fishing dehooker device, in accordance with an embodiment.

FIGS. 12A-12C are sequential views of a fish dehooker device being used to dehook a fish from a fishing hook and line, in accordance with an embodiment.

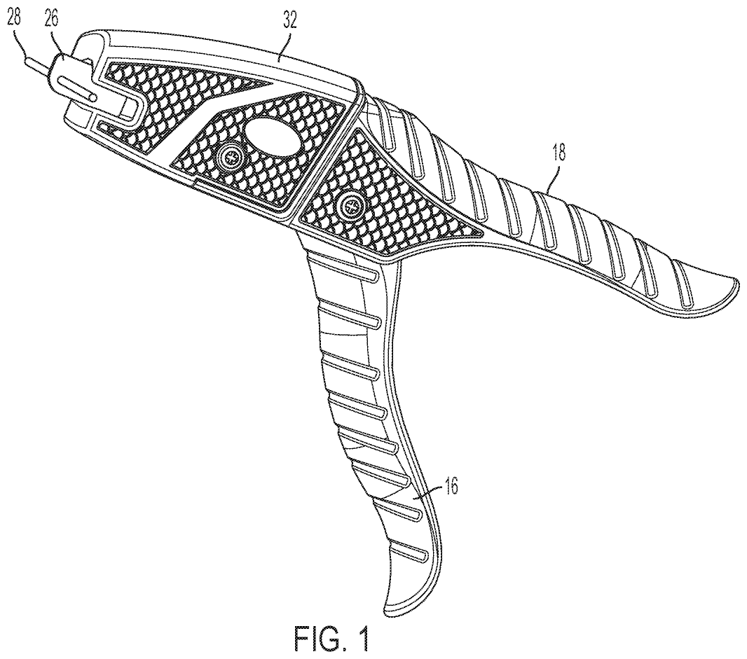

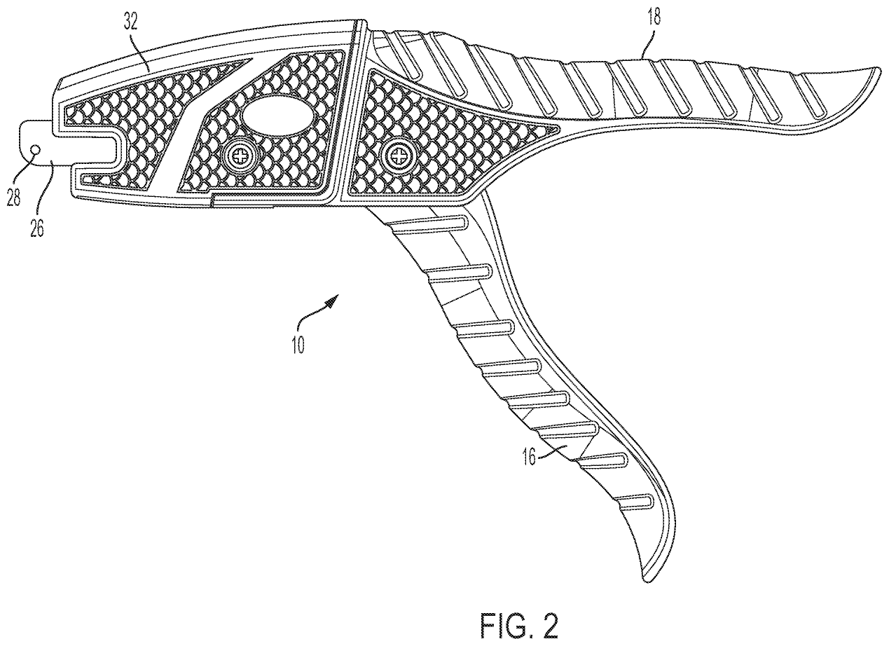

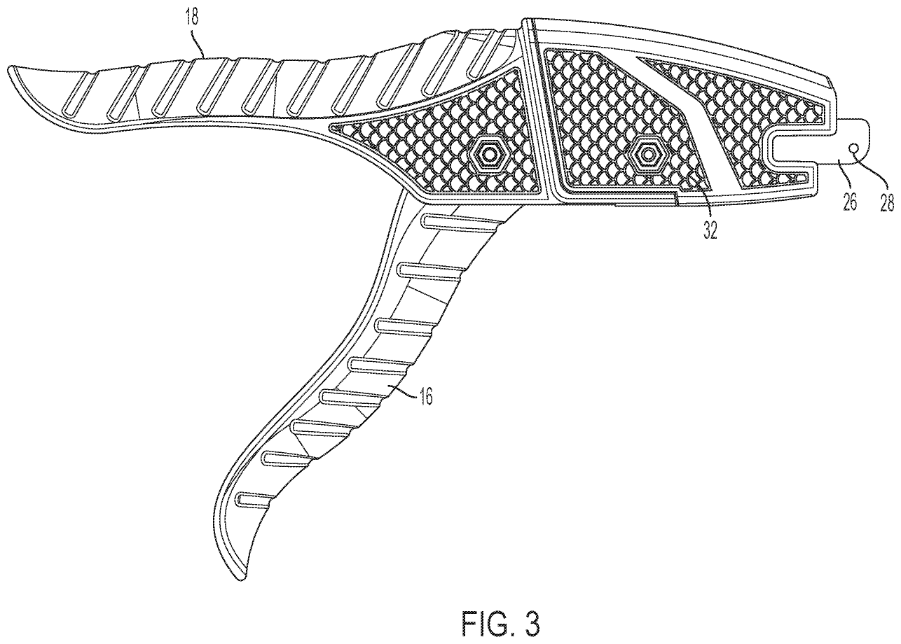

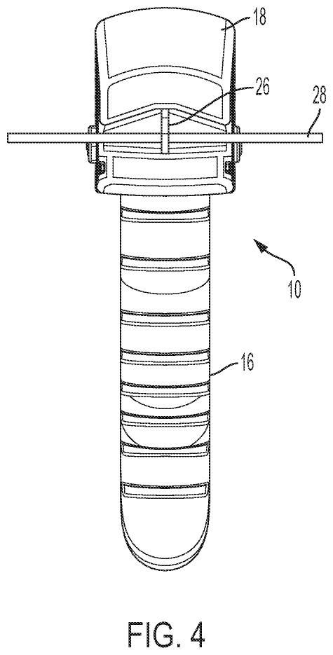

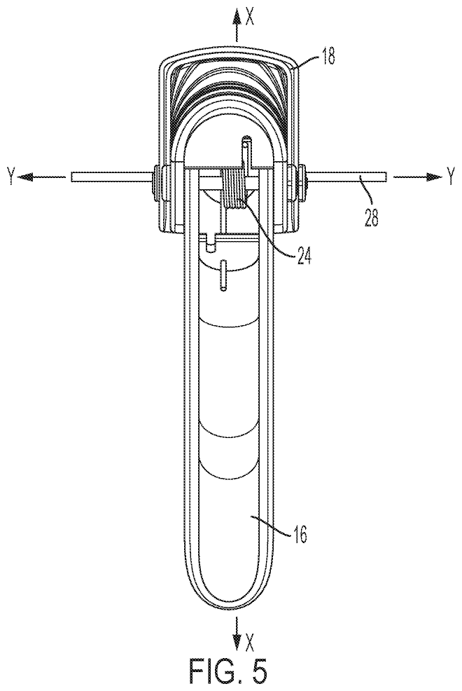

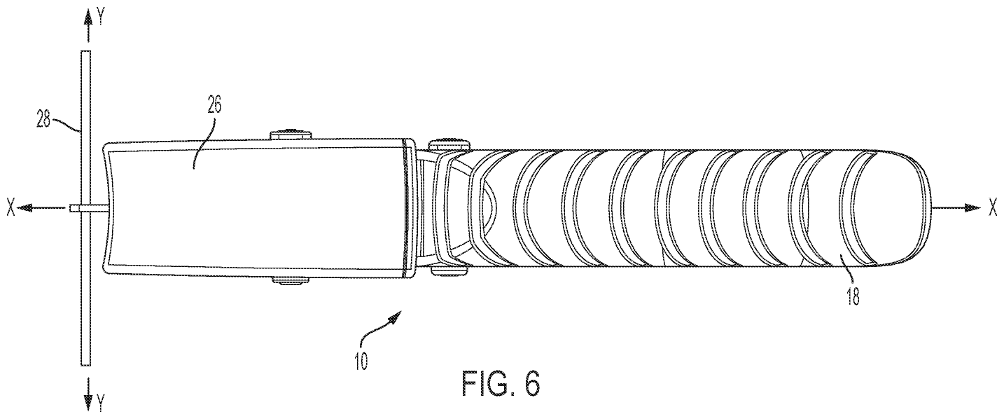

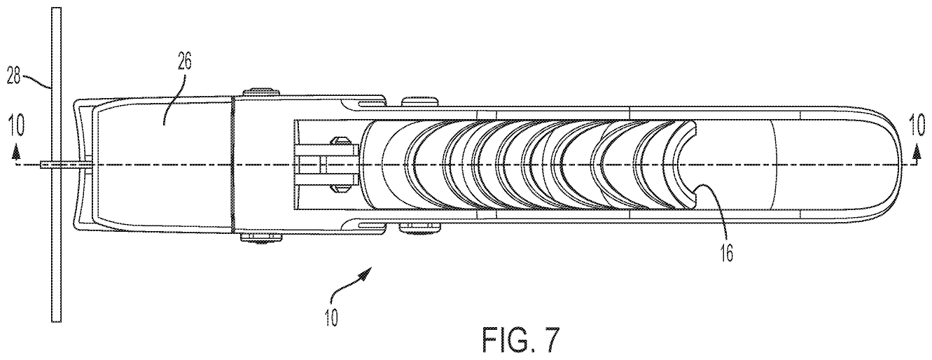

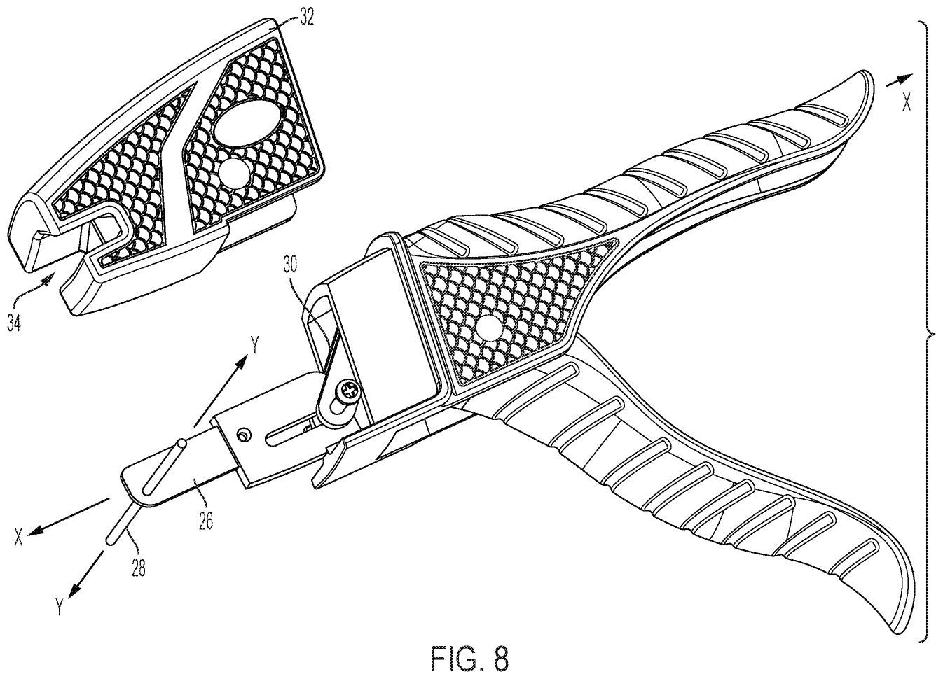

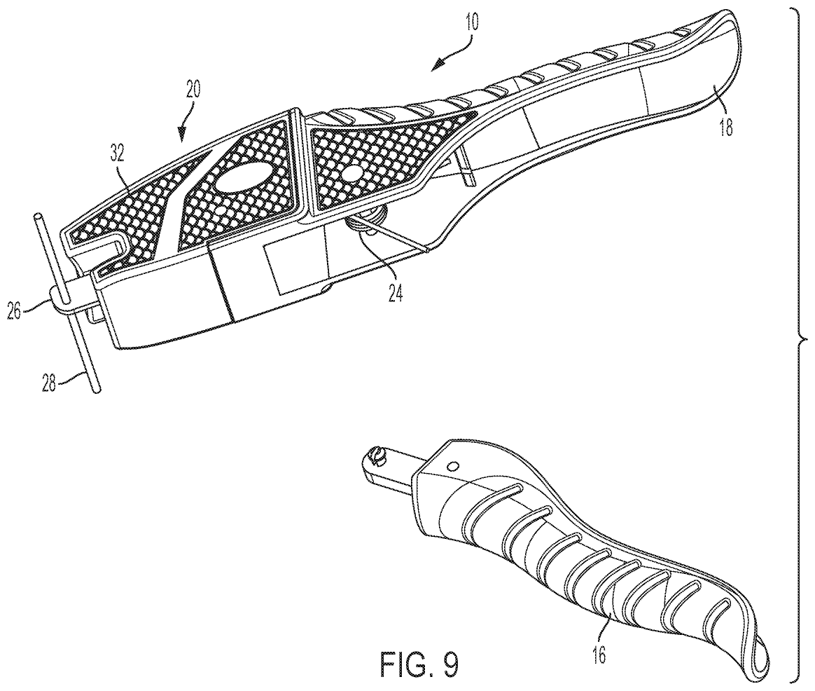

### DETAILED DESCRIPTION OF EMBODIMENTS

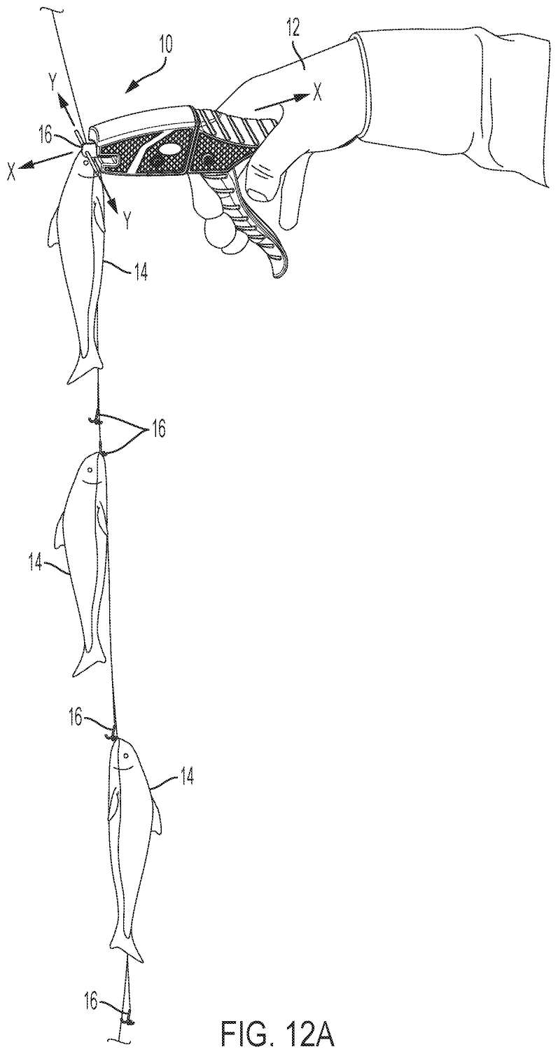

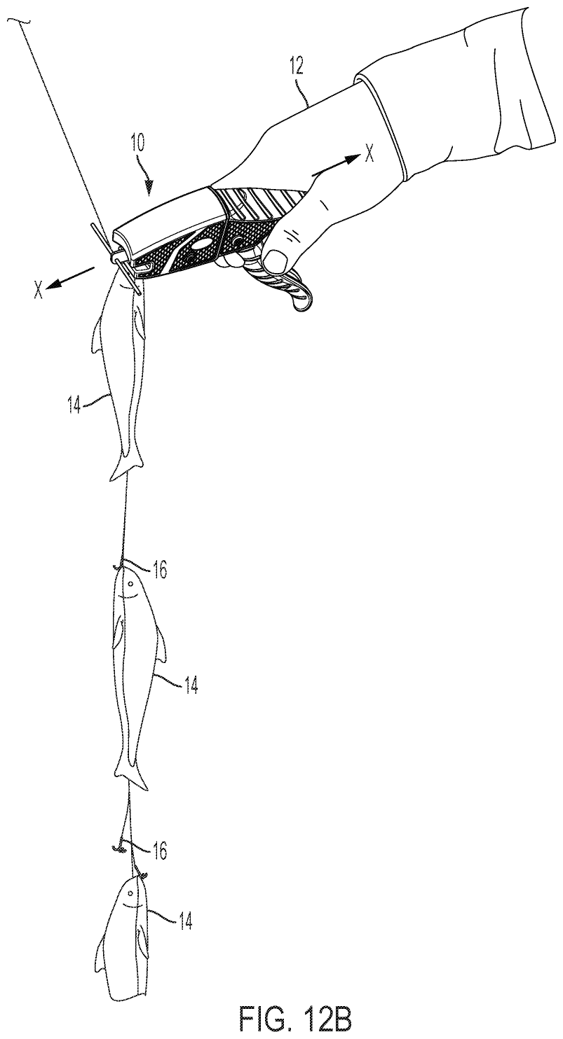

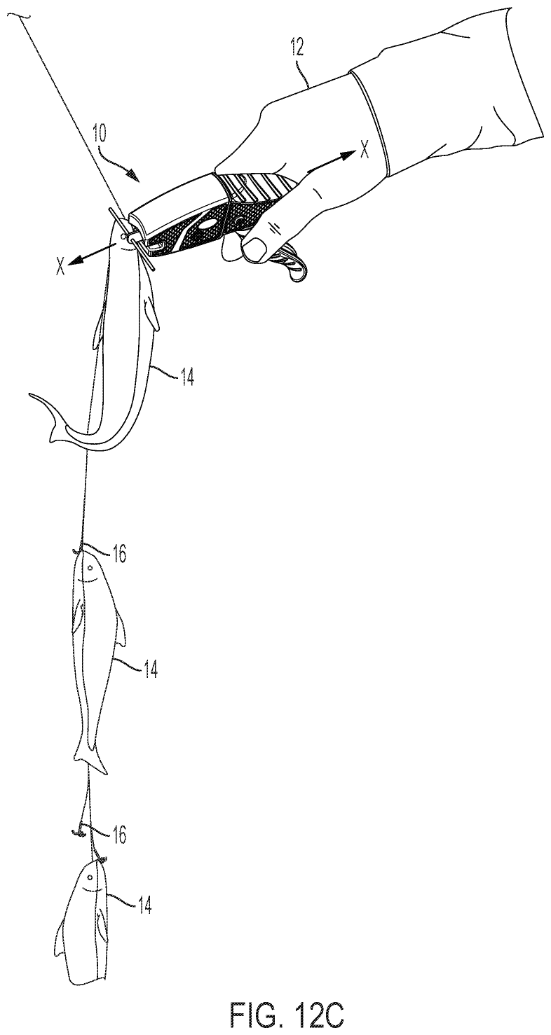

The present disclosure describes a fish dehooking device, designated generally by reference numeral 10 for permitting a fisherman 12 to separate a fish 14 from a fishing hook and line 16 (see FIGS. 12A-12C). In addition, it also pushes fish off the hook in a trajectory such that it is easy to catch the fish in a live well or bucket filled with water to further maintain the fish's health to a significant degree.

Referring to the FIGURES, in one embodiment, fish dehooking device 10 generally comprises first and second handles 16, 18 associated with a dehooking head assembly, designated generally by reference numeral 20. First handle 16 is selectively, pivotally movable towards and away from second handle 18. Manual movement of first handle 16 by fisherman 12 is what will cause dehooking head assembly 20 to operably detach fish 14 from line/hook 16, as will be further described hereinafter.

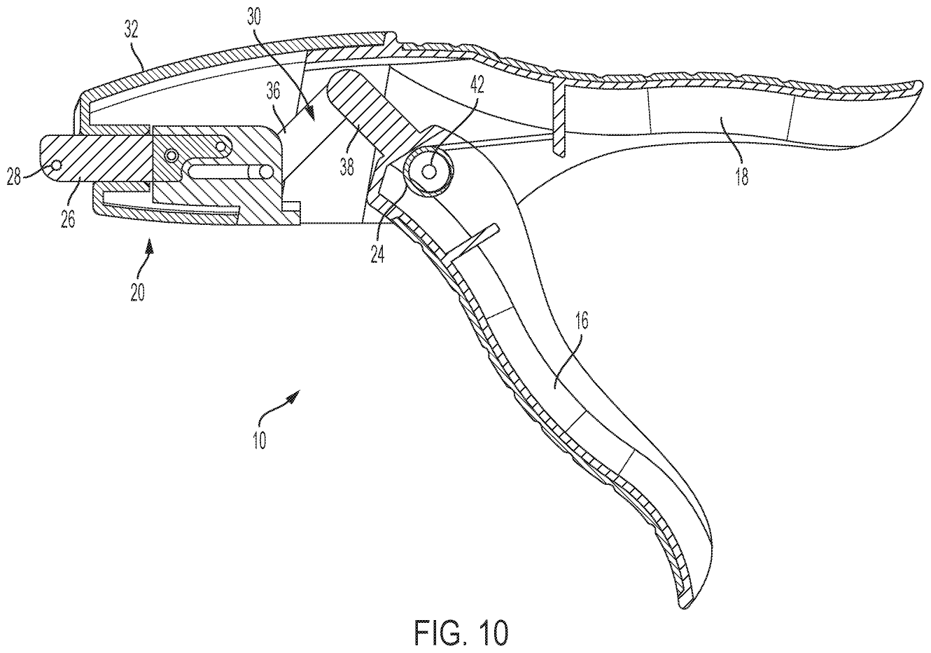

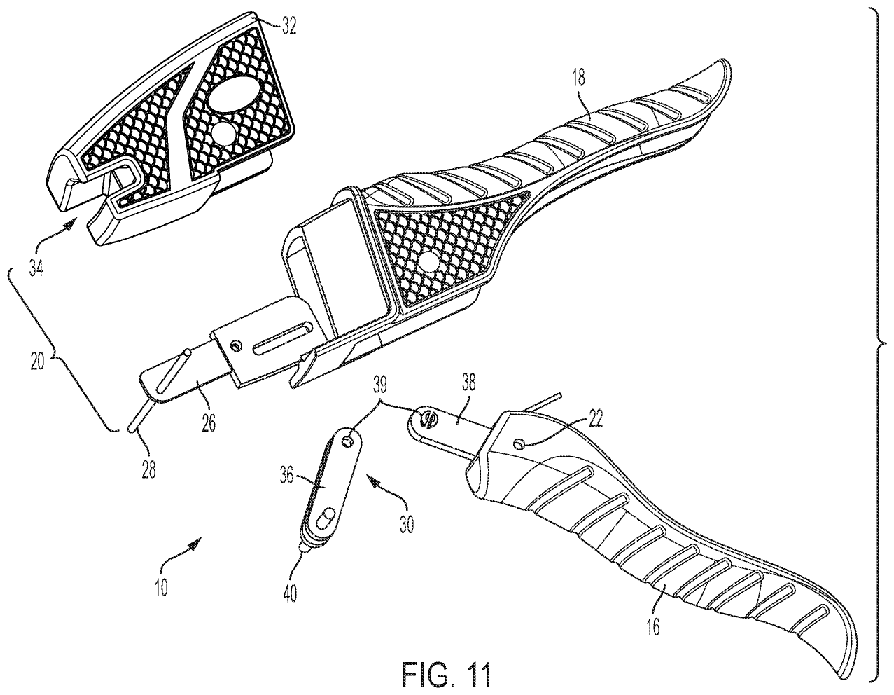

Referring to FIG. 10 first handle 16 is pivotally connected to second handle 18 by a pin/connector 22 and a spring 24 that biases first handle 16 to its fully open position (farthest away from second handle 18). Fisherman 12 can grasp handles 16, 18 and squeeze handle 16 towards handle 18 with a force that is greater than that of the spring 24 causing pivotal movement (about pin/connector 22) towards its closed position (where handles 16 and 18 will be closest together).

Dehooking head assembly 20 is operably connected to/associated with handles 16, 18 and generally comprises an (i) elongated dehooking tab 26 having distal and proximal ends and which is reciprocally movable along a longitudinal axis X-X, (ii) a fish hook and line rod 28 extending through the dehooking tab 26 adjacent the distal end thereof along an axis Y-Y that is transverse to the longitudinal axis X-X; (iii) a pin and pivot link assembly 30 attaching the dehooking tab 26 to the first handle 16, whereby pivotal movement of the first handle 16 is translated into linear movement of the pin and pivot link assembly 30; and (iv) a dehooking cover 32 that is positioned in covering relation to a portion of the dehooking tab 26 and in uncovered relation to the fish hook and line rod 28, and comprising a slot 34 formed therein in a position that permits reciprocal movement of the fish hook and line rod 28 into and out of the slot 34. Pin and pivot link assembly 30 comprise first and second elongated linkages 36, 38 pivotally connected to one another by a pin/connector 39 at respective ends, a pin/connector 40 that attaches linkage 36 to dehooking tab 26 and a pin/connector 42 that connects linkage 38 to handle 16.

To operate dehooking device 10, as illustrated in FIGS. 12A-12C, once a fish 12 is on the line/hook 14, first the line/hook 14 is positioned against/adjacent dehooking tab 26 and between fish hook and line rod 28 and slot 34; second, handle 16 is squeezed towards handle 18 causing fish hook and line rod 28 to slidingly move in the direction of axis X-X towards slot 34; third, as shown in FIG. 12B, device 10 is rotated about axis X-X causing fish 14 and hook/line 16 to engage cover 32 resulting from this force in fish 14 disengaging from hook/line 16. On a multi-hook line as is shown in FIGS. 12A-12C, fisherman 12 can then simply slide device 10 down line 16 to the next hook and remove that fish 14 in the same manner. Based on the manner the fish is forced off the hook, it is also directed in a particular trajectory that makes catching the fish in a live well or bucket a simple task.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A fish dehooking device for permitting a fisherman to separate a fish from a fishing hook and line, comprising:
a. first and second handles adapted to be gripped by the fisherman, the first handle being biased in an open position and being selectively, manually and pivotally movable towards the second handle through exertion of force to overcome the bias; and
b. a dehooking head assembly comprising:
i. an elongated dehooking tab reciprocally movable along a longitudinal axis and interconnected to the first handle, comprising distal and proximal ends;
ii. a fish hook and line rod attached to the dehooking tab adjacent the distal end thereof;
iii. a pin and pivot link assembly attaching the dehooking tab to the first handle, whereby pivotal movement of the first handle is translated into linear movement of the pin and pivot link; and
iv. a dehooking cover comprising a slot formed therein in a position that permits reciprocal movement of the fish hook and line rod into and out of the slot.

2. The fish dehooking device of claim 1, wherein the bias is created by a spring that interconnects the first handle to the second handle.

3. The fish dehooking device of claim 1, wherein the fish hook and line rod extends along an axis that is transverse to the longitudinal axis.

4. The fish dehooking device of claim 1, wherein the pin and pivot link assembly comprise:
a. first and second elongated linkages pivotally connected to one another at respective ends thereof by a first pin;
b. a second pin that attaches the first elongated linkage to the dehooking tab; and
c. a third pin that connects the second elongated linkage to the first handle.

5. The fish dehooking device of claim 1, wherein the dehooking cover is positioned in covering relation to a portion of the dehooking tab and in uncovered relation to the fish hook and line rod.

6. A method for separating a fish from a fishing hook and line using a fish dehooking device having first and second handles pivotally connected to one another and a dehooking head assembly that is reciprocally movable in response to pivotal movement of the first and second handles and includes a slotted cover into which and out of which the dehooking head assembly is reciprocally movable, comprising the steps of:
a. positioning the hook and line adjacent to the dehooking head assembly;
b. pivotally moving the first handle towards the second handle, whereby the dehooking head assembly to move towards the slotted cover; and
c. rotating the dehooking device while the first handle is pivotally moved towards the second handle.

7. The method for separating a fish from a fishing hook and line according to claim 6, comprising the further step of sliding the dehooking device along the fishing line until a fish caught on a second fishing hook is engaged.
